(19) United States
(12) Patent Application Publication
(10) Pub. No.: US 2016/0020899 A1
(43) Pub. Date: Jan. 21, 2016

(54) DECRYPTING DEVICE, ENCRYPTING DEVICE, COMPUTER PROGRAM PRODUCT, RECORDING MEDIUM, AND MANUFACTURING METHOD

(71) Applicant: KABUSHIKI KAISHA TOSHIBA, Tokyo (JP)

(72) Inventors: Taku KATO, Kamaura (JP); Jun SATO, Tokyo (JP)

(21) Appl. No.: 14/480,177

(22) Filed: Sep. 8, 2014

(30) Foreign Application Priority Data
Sep. 13, 2013 (JP) 2013-190841

(51) Int. Cl. H04L 9/08; H04L 9/14

(52) U.S. Cl. CPC H04L 9/0816; H04L 9/14; H04L 2209/24

(57) ABSTRACT

According to an embodiment, a decrypting device includes data decryptors to decrypt encrypted data through processes different from one another; and key generators provided respectively corresponding to the data decryptors, to generate key information to be used in corresponding decryption processes. A key tree includes nodes in a tree structure. Lowermost nodes among the nodes are leaves respectively associated with playback devices. Device keys different from one another are assigned to the nodes. Each key generator includes a device key holder and a key decryptor. The device key holder holds the device keys assigned to the nodes. The key decryptor acquires key management information containing one or more pieces of encrypted key information each obtained by encrypting the key information by using each of one or more device keys; selects one device key, and generates the key information by decrypting the key management information by using the selected device key.

### CROSS-REFERENCE TO RELATED APPLICATIONS

This application is based upon and claims the benefit of priority from Japanese Patent Application No. 2013-190841, filed on Sep. 13, 2013; the entire contents of which are incorporated herein by reference.

### FIELD

Embodiments described herein relate generally to a decrypting device, an encrypting device, a computer program product a recording medium, and a manufacturing method.

### BACKGROUND

A Blu-ray disc (BD; registered trademark) has key management information called a media key block (MKB) recorded thereon for the purpose of content protection. This can prohibit reproduction from the BD using an unauthorized device. Generation of an MKB to prohibit reproduction from a BD using an unauthorized device is called revocation.

Furthermore, a content protection technology called BD+ using a virtual machine is adopted for BDs in addition to the content protection using the MKB. Protection for BDs is enhanced by adopting such two different content protection technologies.

With the advance in technology, content protection needs to be further enhanced. To generate an MKB for revoking a certain device, the secret key held by the device suspected to be unauthorized has to be identified as a prerequisite therefor. It is, however, very difficult to identify a secret key held by a device.

### BRIEF DESCRIPTION OF THE DRAWINGS

FIG. 1 is a schematic diagram of the configuration of an encryption system according to an embodiment;

FIG. 2 is a schematic diagram of the configuration of a decryptor according to the embodiment;

FIG. 3 is a diagram illustrating a data structure of a first MKB;

FIG. 4 is a diagram illustrating a data structure of a first KCD seed block;

FIG. 5 is a schematic diagram of the configuration of an encryptor according to the embodiment;

FIG. 6 illustrates a key tree in which device keys are assigned;

FIG. 7 illustrates an example of device keys distributed to playback devices;

FIG. 8 illustrates an example of device keys used for encryption not in unauthorized use;

FIG. 9 illustrates another example of device keys used for encryption not in unauthorized use;

FIG. 10 illustrates an example of device keys used for encryption in unauthorized use;

FIG. 11 illustrates an example of a key tree in which KCD keys are assigned;

FIG. 12 is a flowchart of a decryption process;

FIG. 13 is a flowchart of a first decryption process;

FIG. 14 is a flowchart of a second decryption process;

FIG. 15 illustrates device keys used for encryption of a first MKB;

FIG. 16 illustrates device keys used for encryption of a second MKB; and

FIG. 17 is a schematic diagram of a hardware configuration of the encryptor and the decryptor.

### DETAILED DESCRIPTION

According to an embodiment, a decrypting device includes multiple data decryptors configured to decrypt encrypted data through processes different from one another; and multiple key generators provided respectively corresponding to the data decryptors, and configured to generate key information to be used in corresponding decryption process. A key tree includes multiple nodes in a tree structure. Lowermost nodes among the nodes are leaves. The leaves are respectively associated with playback devices. Device keys different from one another are respectively assigned to the nodes. Each of the key generators includes a device key holder and a key decryptor. The device key holder holds the device keys assigned to the nodes in the key tree. The key decryptor acquires key management information containing one or more pieces of encrypted key information each obtained by encrypting the key information by using each of one or more device keys selected from the key tree; selects one device key that can be used for decryption of the key management information from the device keys held by the key device holder, and generates the key information by decrypting the key management information by using the selected device key.

Overall Configuration

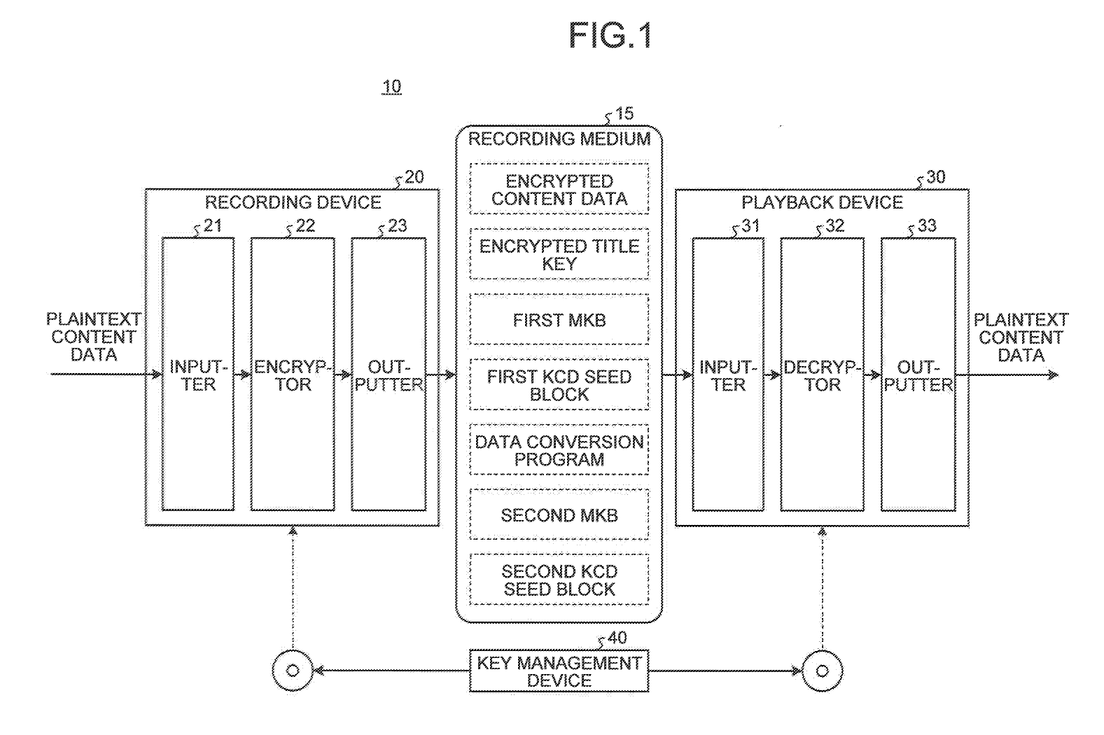

FIG. 1 illustrates the configuration of an encryption system 10 according to an embodiment. The encryption system 10 includes a recording device 20 configured to record data on a recording medium 15, a playback device 30 configured to reproduce data from the recording medium 15, and a key management device 40.

The recording medium 15 is an optical disc such as a Blu-ray disc (BD; registered trademark) or a digital versatile disc (DVD; registered trademark), for example. The recording medium 15 may be a semiconductor memory, a magnetic disk such as a hard disk, or the like.

The recording device 20 includes an inputter 21, an encryptor 22 (encrypting device), and an outputter 23. The inputter 21 inputs plaintext context data from the external. The encryptor 22 generates encrypted content data, an encrypted title key, a first media key block (MKB), a first key conversion data (KCD) seed block, a data conversion program, a second MKB, and a second KCD seed block on the basis of the plaintext content data or the like input by the inputter 21.

The outputter 23 records the respective data generated by the encryptor 22 in predetermined areas of the recording medium 15.

Such a recording device 20 is used in manufacturing facilities with the authorization of the right holder of the content. Alternatively, the recording device 20 may acquire plaintext content data provided via a communication channel or a broadcast with the authorization of the right holder of the content, and record the data.

The playback device 30 reproduces the data recorded on the recording medium 15 by the recording device 20. The playback device 30 includes an inputter 31, a decryptor 32 (decrypting device), and an outputter 33.

The inputter 31 acquires the encrypted content data, the encrypted title key, the first MKB, the first KCD seed block, the data conversion program, the second MKB, and the second KCD seed block from the recording medium 15. The decryptor 32 generates plaintext content data on the basis of the data acquired by the inputter 31. The outputter 33 outputs the plaintext content data generated by the decryptor 32 to the external.

Such a playback device 30 is used by a user. The decryptor 32 of the playback device 30 may be software executed by a computer, or may be partly or entirely hardware. The playback device 30 may have a configuration including another device between the inputter 31 and the decryptor 32.

The key management device 40 is a server managed by a key management organization or the like, for example. The key management device 40 manages various information data necessary for recording data on the recording medium 15. The key management device 40 distributes various information data required for recording data on the recording medium 15 to manufacturers of the recording medium 15 via a medium such as a DVD or a network. A manufacturer of the recording medium 15 provides the distributed information to the recording device 20 to create the recording medium 15. The key management device 40 also distributes various information data required for reproducing data from the recording medium 15 to manufacturers of the playback device 30 via a medium such as a DVD. A manufacturer of the playback device 30 writes the distributed information into the playback device 30 to allow reproduction from the recording medium 15 using the playback device 30.

Data

The plaintext content data are audio/visual data encoded according to a predetermined method, for example. The plaintext content data may be any digital data such as audio data, static image data, electronic book data, or game program data.

The encrypted content data are data obtained by encrypting the plaintext content data according to multiple different methods. In the present embodiment, the encrypted content data are data obtained by performing two encryption processes on the plaintext content data. One encryption process is a data conversion process of converting the plaintext content data into intermediate content data by replacing part of the plaintext content data with other data and generating a program code and a conversion table to generate the data part before replacement. The other process is an encryption process of encrypting the intermediate content data by using a plaintext title key.

The encrypted title key is data obtained by encrypting the plaintext title key by using a first media key. Alternatively, one plaintext content data may be divided, and the respective pieces of data resulting from the division may be subjected to the encryption process by using different plaintext title keys.

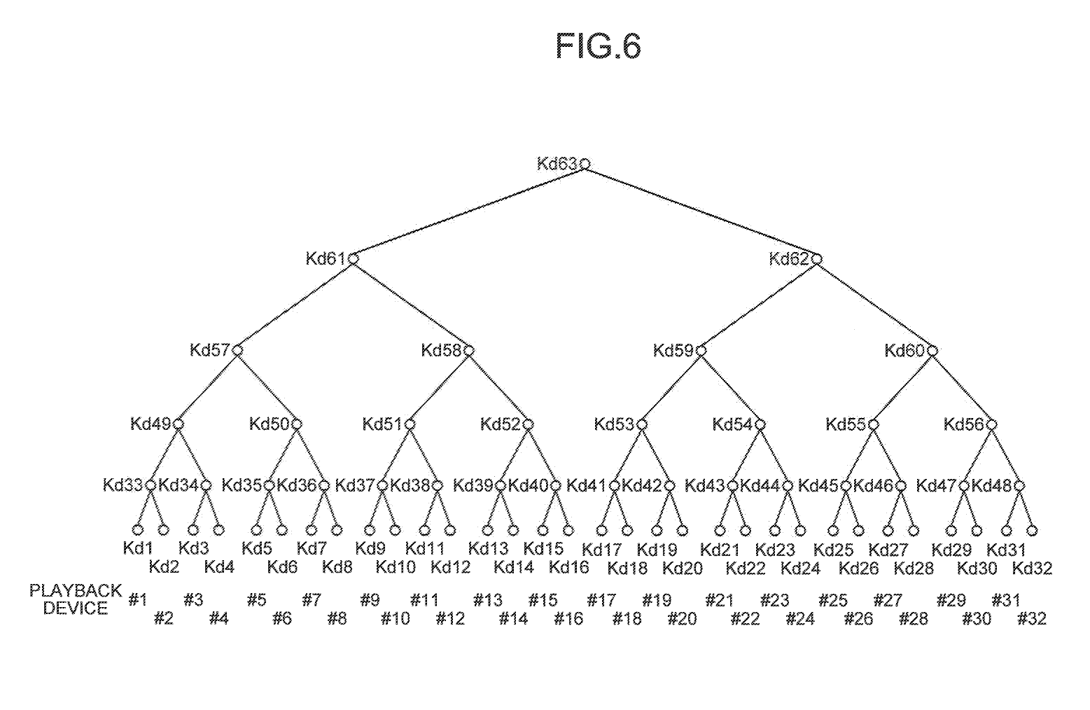

The first MKB is information for allowing an authorized playback device 30 to generate a first intermediate key on which the first media key is based. The first KCD seed block is information for allowing an authorized playback device 30 to generate a first KCD value. The first KCD seed block contains first position information. The first position information is information indicating which device key is used to decrypt the first intermediate key. The first media key is data generated on the basis of the first intermediate key, the first KCD value, and the first position information. The first MKB and the first KCD value will further be described later in detail with reference to FIG. 6 and subsequent drawings.

The data conversion program contains a program code in JAVA (registered trademark) or the like to be executed by a virtual machine, and the conversion table in which conversion data that is part of the plaintext content data is registered. The data conversion program is successfully executed by inputting a second media key to the virtual machine. The plaintext content data is data generated by replacing part of the intermediate content data with the conversion data generated by the virtual machine as a result of execution of the program code. The encryptor 22 generates the data conversion program and the conversion data by a method taught in U.S. Pat. No. 8,046,837, for example.

The second MKB is information for allowing an authorized playback device 30 to generate a second intermediate key on which the second media key is based. The second KCD seed block is information for allowing an authorized playback device 30 to generate a second KCD value. The second KCD seed block contains second position information. The second position information is information indicating which device key is used to decrypt the second intermediate key. The second media key is data generated on the basis of the second intermediate key, the second KCD value, and the second position information. The second MKB and the second KCD value will further be described later in detail with reference to FIG. 6 and subsequent drawings.

Configuration of Decryptor 32

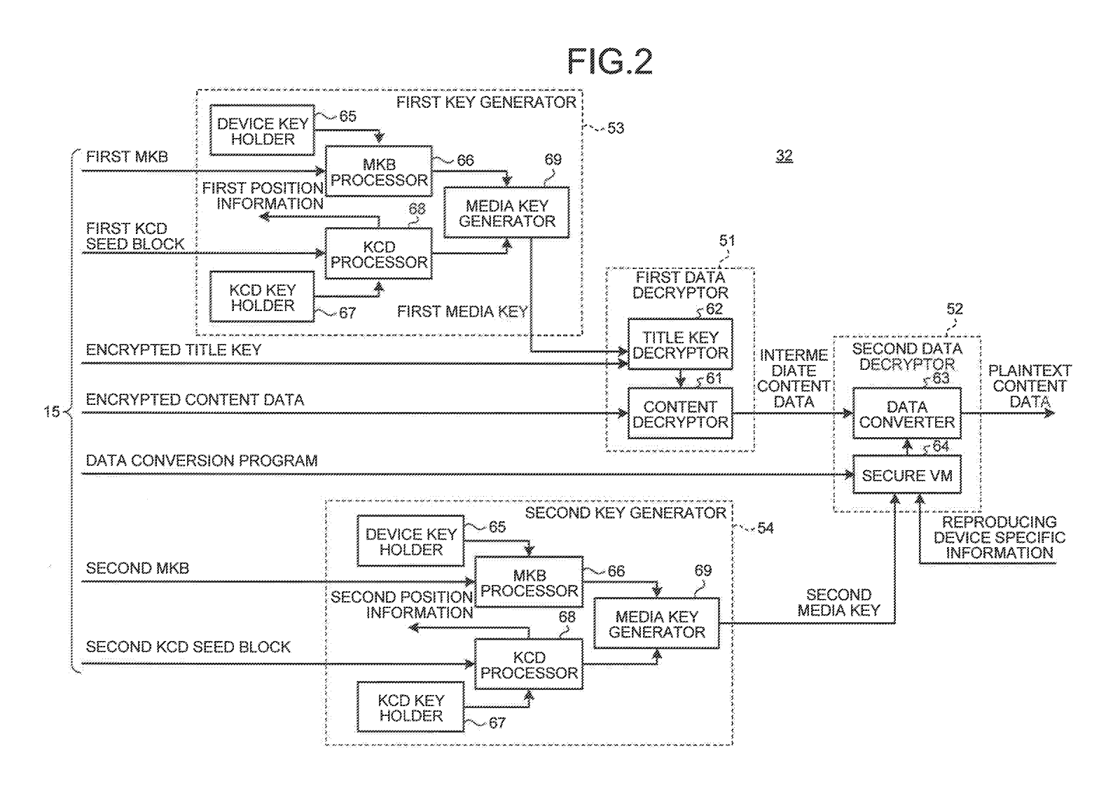

FIG. 2 illustrates a configuration of the decryptor 32. The decryptor 32 includes a first data decryptor 51, a second data decryptor 52, a first key generator 53, and a second key generator 54.

The first data decryptor 51 and the second data decryptor 52 decrypt encrypted data (encrypted content data) through processes different from each other. The first key generator 53 is provided corresponding to the first data decryptor 51, and generates the first media key (first key information) used in the decryption process of the corresponding first data decryptor 51. The second key generator 54 is provided corresponding to the second data decryptor 52, and generates the second media key (second key information) used in the decryption process of the corresponding second data decryptor 52.

More specifically, the first data decryptor 51 includes a content decryptor 61 and a title key decryptor 62. The content decryptor 61 acquires encrypted content data from the recording medium 15. The content decryptor 61 decrypts the encrypted content data by using a plaintext title key generated by the title key decryptor 62 to generate intermediate content data.

The title key decryptor 62 acquires an encrypted title key from the recording medium 15. The title key decryptor 62 decrypts the encrypted title key by using the first media key generated by the first key generator 53 to generate the plaintext title key.

The second data decryptor 52 includes a data converter 63 and a secure VM 64. The data converter 63 replaces part of the intermediate content data with conversion data generated by the secure VM 64 to generate plaintext content data.

The secure VM 64 acquires the data conversion program from the recording medium 15. The data conversion program contains the program code and the conversion table in which the conversion data is registered. The secure VM 64 executes the program code on a secure virtual machine to output the conversion data registered in the conversion table.

The secure VM 64 also executes a process on the basis of playback device specific information held in the playback device 30. The secure VM 64 also acquires the second media key from the second key generator 54 and executes normal operation when the acquired second media key has a valid value.

The first key generator 53 includes a device key holder 65, an MKB processor 66 (key decryptor), a KCD key holder 67, a KCD processor 68 (position detector), and a media key generator 69.

The device key holder 65 secretly holds multiple device keys. Note that the key management device 40 manages a key tree. The key tree includes multiple nodes arranged in a tree structure. The lowermost nodes of the multiple nodes are referred to leaves. The leaves of the key tree are associated with multiple playback devices 30, respectively. In addition, device keys that are different from one another are assigned to the respective nodes of the key tree.

The device key holder 65 holds device keys assigned to nodes on a path from the root (the top of a tree structure) or a certain node at an intermediate level to the leaf associated with the playback device 30 in such a key tree. Such multiple device keys are stored into the device key holder 65 by the manufacturer who has acquired the device keys from the key management device 40 via a medium such as a DVD or a network during manufacture or the like.

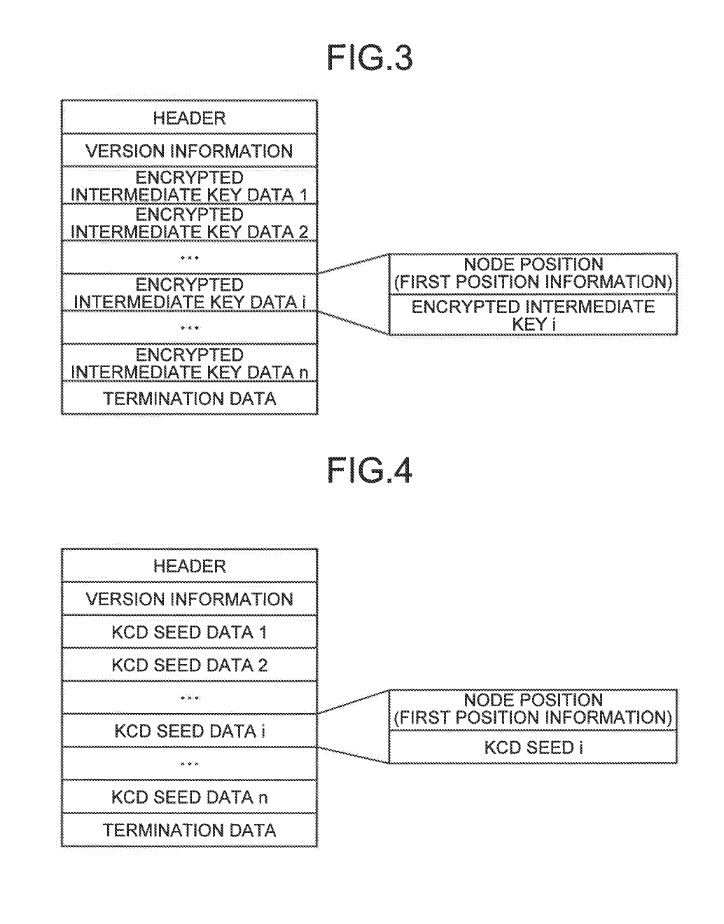

The MKB processor 66 acquires the first MKB (first key management information) from the recording medium 15. The first MKB contains a header, version information, one or more encrypted intermediate key data, and termination data as illustrated in FIG. 3, for example. Each of one or more encrypted intermediate key data contains a node position (first position information) and an encrypted intermediate key. The one or more encrypted intermediate keys contained in the first MKB are data generated by encrypting intermediate keys by using one or more device keys, respectively, selected from the key tree. The one or more pieces of first position information contained in the first MKB indicate positions in the key tree of the device keys used to generate the associated encrypted keys that are also contained.

The one or more device keys used to generate one or more encrypted intermediate keys contained in the first MKB are selected by the key management device 40. In this case, the key management device 40 selects one or more device keys so that all of the playback devices 30 except for playback devices 30 to be revoked each hold one device key. In other words, the one or more encrypted intermediate keys contained in the first MKB are data generated by encrypting intermediate keys respectively by one or more device keys selected so that all of the playback devices 30 except for playback devices 30 to be revoked each hold one device key.

The MKB processor 66 then decrypts the first MKB by using the device keys held by the device key holder 65 to generate an intermediate key. More specifically, the MKB processor 66 selects one device key capable of decrypting one of the encrypted intermediate keys contained in the first MKB from the device keys held by the device key holder 65, and executes a process of decrypting the encrypted intermediate key. When the device keys held by the device key holder 65 are valid, the MKB processor 66 can decrypt one of the encrypted intermediate keys contained in the first MKB. The MKB processor 66 outputs one decrypted intermediate key.

The KCD key holder 67 secretly holds multiple KCD keys assigned to nodes on a path from the root or a certain node at an intermediate level to the leaf associated with the playback device 30 in the key tree. The key tree in which the KCD keys are assigned is managed by the key management device 40. The key tree in which the KCD keys are assigned has a tree structure having the same branch pattern as the key tree in which the device keys are assigned, and the same playback devices 30 as those in the key tree of the device keys are associated with the respective leaves.

The KCD processor 68 acquires the first KCD seed block from the recording medium 15. For example, as illustrated in FIG. 4, the first KCD seed block contains a header, version information, one or more KCD seed data, and termination data. Each of one or more KCD seed data contains a node position (first position information) and a KCD seed in association with each other. One or more KCD seeds contained in the first KCD seed block are data generated by converting the KCD value and the first position information by using one or more respective KCD keys selected from the key tree.

The first position information indicates the position of a node in the key tree of the KCD key used to generate the KCD seed that is contained in association therewith. Each of the KCD keys used to encrypt one or more KCD seeds contained in the first KCD seed block is assigned to the node located on the same position as each of the device keys used for encryption of one or more encrypted intermediate keys contained in the first MKB.

The KCD processor 68 then converts the KCD seed in the first KCD seed block by using multiple KCD keys held by the KCD key holder 67 and generates the KCD value and the first position information indicating the node position corresponding to the KCD key used for the conversion. More specifically, the KCD processor 68 selects one KCD key capable of generating a valid KCD seed from multiple KCD keys held by the KCD key holder 67, and executes a process of generating the KCD seed. The KCD processor 68 can generate a KCD value from one of the KCD seeds contained in the first KCD seed block by using one of the KCD keys when the KCD keys held by the KCD key holder 67 are valid.

The KCD processor 68 outputs the generated KCD value. The KCD processor 68 also outputs the first position information to a data area that can be referred to from outside of the playback device 30 (that is, a data area that is not secure). The first position information output by the KCD processor 68 indicates the position of a node in the key tree to which the KCD key used to decrypt the KCD seed contained in the first KCD block is assigned. In other words, the first position information indicates the position of a node in the key tree to which the device key used to decrypt an encrypted intermediate key contained in the first MKB is assigned.

The media key generator 69 generates the first media key on the basis of the intermediate key generated by the MKB processor 66, and the KCD value and the first position information generated by the KCD processor 68. The media key generator 69 then provides the generated first media key to the first data decryptor 51.

The second key generator 54 has substantially the same functions and configuration as the first key generator 53. Thus, description of the second key generator 54 will be made focusing on differences from the first key generator 53.

The second key generator 54 differs from the first key generator 53 in acquiring the second MKB (second key management information) in place of the first MKB and in acquiring the second KCD seed block in place of the first KCD seed block. The second key generator 54 also differs from the first key generator 53 in outputting the second media key in place of the first media key.

A device key holder 65 of the second key generator 54 may hold the same device keys as the device key holder 65 of the first key generator 53 or may hold device keys assigned to the same positions of nodes in the key tree as but having different values from the device keys held by the device key holder 65 of the first key generator 53. A KCD key holder 67 of the second key generator 54 may hold the same KCD keys as the KCD key holder 67 of the first key generator 53 or may hold KCD keys assigned to the same positions of nodes in the key tree as but having different values from the KCD keys held by the KCD key holder 67 of the first key generator 53.

An MKB processor 66 of the second key generator 54 acquires the second MKB from the recording medium 15. The second MKB has the same data structure as the first MKB illustrated in FIG. 3. Note that one or more encrypted intermediate keys contained in the second MKB are data generated by encrypting the intermediate key by using one or more device keys selected so that a node combination pattern different from that of one or more encrypted intermediate keys contained in the first MKB is obtained.

A KCD processor 68 of the second key generator 54 acquires the second KCD seed block from the recording medium 15. The second KCD seed block has the same data structure as the first KCD seed block illustrated in FIG. 4. The KCD processor 68 of the second key generator 54 converts the KCD seed in the second KCD seed block by using multiple KCD keys held by the KCD key holder 67 and generates the KCD value and the second position information. The second position information indicates the position of a node in the key tree to which the KCD key used to generate the KCD value by converting the KCD seed contained in the second KCD seed block. In other words, the second position information indicates the position of a node in the key tree to which the device key used to decrypt an encrypted intermediate key contained in the second MKB is assigned. The KCD processor 68 of the second key generator 54 outputs the second position information to a data area that can be referred to from outside of the playback device 30.

A media key generator 69 of the second key generator 54 generates the second media key on the basis of the intermediate key generated by the MKB processor 66, and the KCD value generated by the KCD processor 68. The media key generator 69 of the second key generator 54 then provides the generated second media key to the second data decryptor 52.

Configuration of Encryptor 22

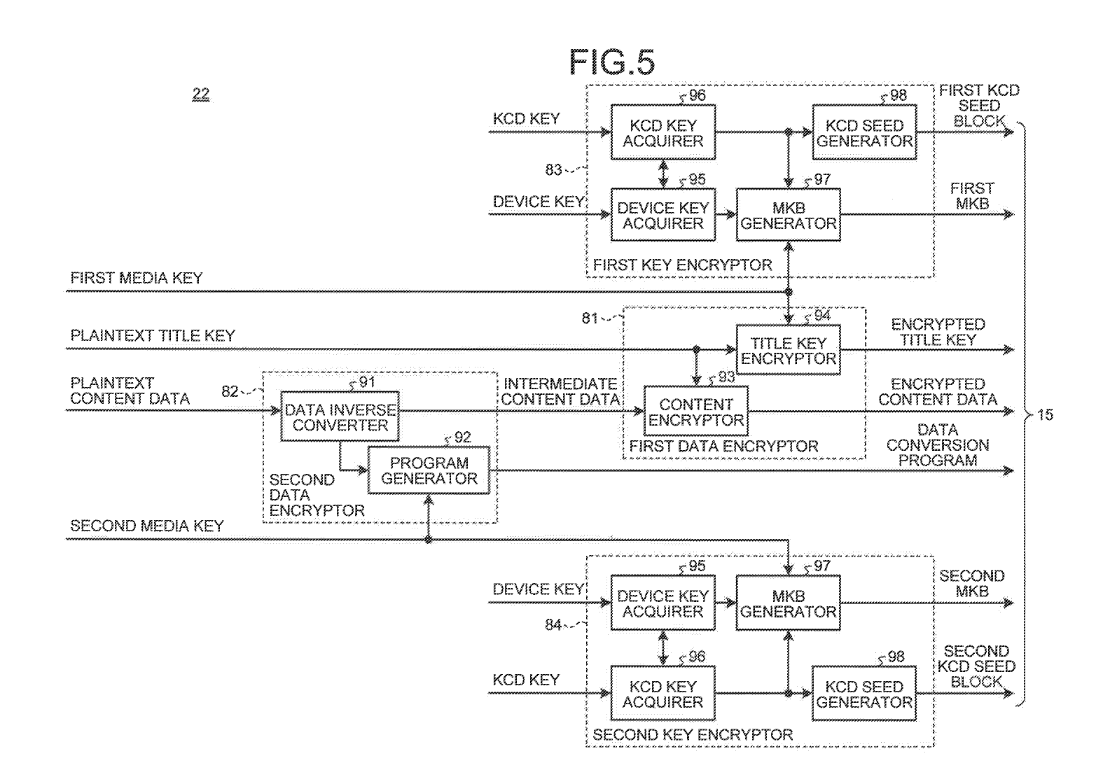

FIG. 5 illustrates a configuration of the encryptor 22. The encryptor 22 includes a first data encryptor 81, a second data encryptor 82, a first key encryptor 83, and a second key encryptor 84.

The first data encryptor 81 and the second data encryptor 82 encrypt plaintext content data through processes different from each other. The first key encryptor 83 is provided corresponding to the first data encryptor 81 and encrypts the first media key (first key information) used in a corresponding decryption process. Specifically, the first key encryptor 83 generates the first MKB and the first KCD seed block.

The second key encryptor 84 is provided corresponding to the second data encryptor 82 and encrypts the second media key (second key information) used in a corresponding decryption process. Specifically, the second key encryptor 84 generates the second MKB and the second KCD seed block.

The second data encryptor 82 includes a data inverse converter 91 and a program generator 92. The data inverse converter 91 acquires plaintext content data. The data inverse converter 91 extracts part of the plaintext content data and provide the extracted part as conversion data to the program generator 92. The data inverse converter 91 also replaces the extracted part with other data generate intermediate content data.

The program generator 92 generates a data conversion program containing a program code and a conversion table in which the conversion data extracted by the data inverse converter 91 is registered. The program generator 92 also acquires the second media key and encrypts the data conversion program so that the data conversion program can be executed by inputting the second media key. The program generator 92 stores the generated data conversion program on the recording medium 15.

The first data encryptor 81 includes a content encryptor 93 and a title key encryptor 94. The content encryptor 93 acquires the intermediate content data generated by the second data encryptor 82 and a plaintext title key. The content encryptor 93 encrypts the intermediate content data by using the plaintext title key to generate encrypted content data. The content encryptor 93 stores the generated encrypted content data on the recording medium 15.

The title key encryptor 94 acquires the plaintext title key and the first media key. The title key encryptor 94 encrypts the plaintext title key by using the first media key to generate an encrypted title key. The title key encryptor 94 stores the generated encrypted title key on the recording medium 15.

The first key encryptor 83 includes a device key acquirer 95, a KCD key acquirer 96, an MKB generator 97 (key information generator), and a KCD seed generator 98 (position information generator).

The device key acquirer 95 acquires one or more device keys selected by the key management device 40 from the key tree managed by the key management device 40. In this case, the key management device 40 selects one or more device keys so that all of the playback devices 30 except for playback devices 30 to be revoked each hold one device key. Furthermore, the device key acquirer 95 also acquires corresponding intermediate keys together with the device keys from the key management device 40, for example.

The KCD key acquirer 96 acquires one or more KCD keys selected by the key management device 40 from the key tree managed by the key management device 40. In this case, the KCD key acquirer 96 acquires KCD keys assigned to the same nodes as the one or more device keys acquired by the device key acquirer 95. The KCD key acquirer 96 acquires corresponding KCD values and position information together with the KCD keys from the key management device 40.

The MKB generator 97 acquires the first media key. Furthermore, the MKB generator 97 acquires one or more device keys and intermediate keys from the device key acquirer 95 and the KCD values and position information from the KCD key acquirer 96. The MKB generator 97 then generates the first MKB on the basis of the acquired information and stores the first MKB on the recording medium 15.

The KCD seed generator 98 acquires the one or more KCD keys, the KCD values, and the position information from the KCD key acquirer 96. The KCD seed generator 98 then generates the first KCD seed block on the basis of the acquired information and stores the first KCD seed block on the recording medium 15.

The second key encryptor 84 has substantially the same functions and configuration as the first key encryptor 83. A device key acquirer 95 of the second key encryptor 84, however, acquires one or more device keys selected so that a different node combination pattern is obtained from the key management device 40. An MKB generator 97 of the second key encryptor 84 generates the second MKB and stores the second MKB on the recording medium 15. A KCD seed generator 98 of the second key encryptor 84 generates the first KCD seed block and stores the second KCD seed block on the recording medium 15.

MKB

Next, the first MKB and the second MKB will be described in more detail. In the present embodiment, the first MKB and the second MKB are described using an example of a media key block (MKB) having a tree structure adopted in an advanced access content system (AACS) or the like. The first MKB and the second MKB will be collectively described as an MKB below.

FIG. 6 illustrates a key tree in which device keys are assigned to multiple nodes in a tree structure. The key management device 40 manages the key tree for generating the MKB. The key tree may have a key structure having a branch pattern in which each parent node branches into two child nodes or a key structure having a branch pattern in which each parent node branches into three or more child nodes.

Multiple playback devices 30 are respectively associated with multiple leaves (at the bottom of the tree structure) of the key tree. In the example of FIG. 6, 32 playback devices 30 are associated with 32 leaves, respectively. To sufficiently cover the expected number of playback devices that will be actually distributed, the key management device 40 actually manages a key structure larger than that of FIG. 6.

Furthermore, in the key tree, device keys that are different from one another are assigned to the respective nodes (nodes having child nodes in the key structure). In the example of FIG. 6, device keys Kd1 to Kd63 are respectively assigned to 63 nodes.

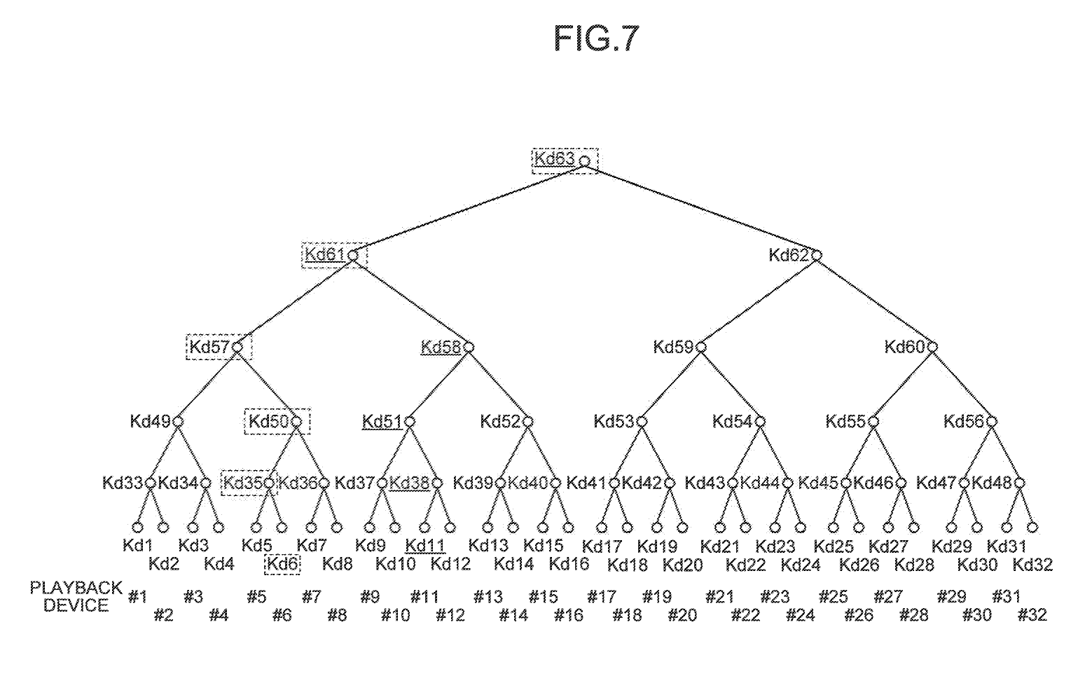

FIG. 7 indicates multiple device keys distributed to the playback device 30 associated with the sixth leaf from the left. Multiple device keys are distributed to each of the playback devices 30 from the key management device 40 during manufacture or the like. Each of the playback devices 30 then secretly holds the distributed device keys so that the device keys will not be exposed to access from outside.

More specifically, each of the playback devices 30 receives multiple device keys assigned to nodes on a path from the root (the node at the top) or a certain node at an intermediate level to the leaf with which the playback device 30 is associated, and secretly holds these device keys. For example, as illustrated in FIG. 7, the playback device 30 associated with the sixth leaf (#6) from the left in the key tree holds {Kd6, Kd35, Kd50, Kd57, Kd61, Kd63}. For another example, as illustrated in FIG. 7, the playback device 30 associated with the eleventh leaf (#11) from the left in the key tree holds {Kd11, Kd38, Kd51, Kd58, Kd61, Kd63}. In this manner, each of the playback devices 30 can hold a combination of device keys different from that of another playback device 30.

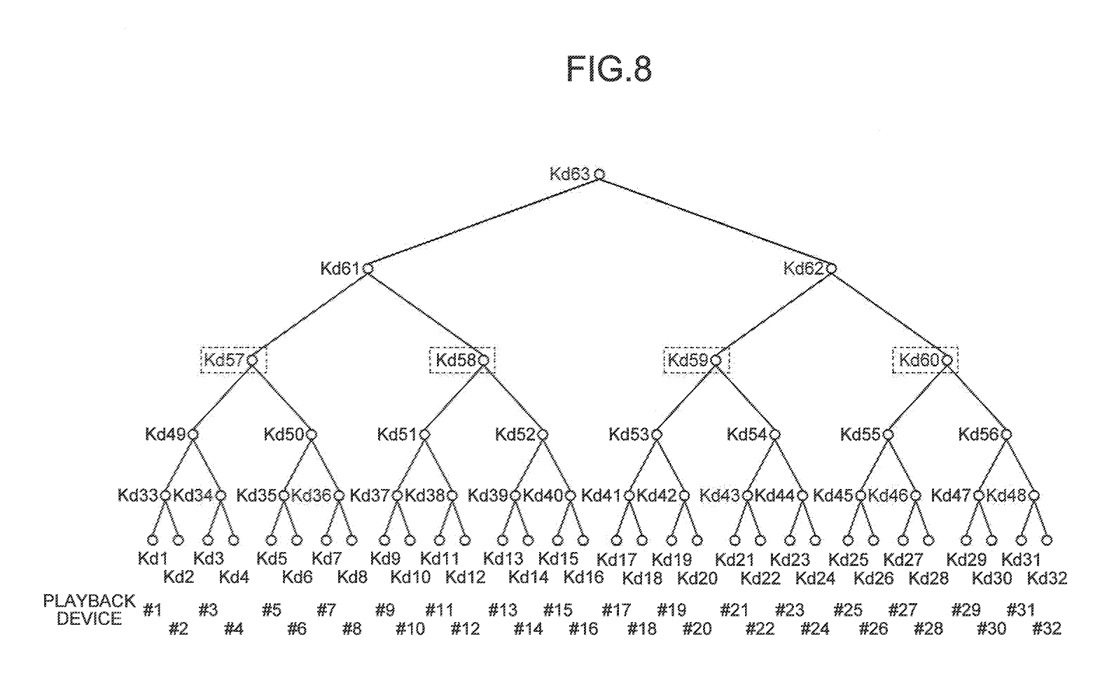

FIG. 8 illustrates an example of a bunch of one or more device keys used to encrypt intermediate keys when there are no device keys subjected to unauthorized use and there are no revoked playback devices.

When there are no device keys subjected to unauthorized use, the key management device 40 selects one or more device keys (a bunch of device keys) from the key tree so that each of all the playback devices 30 has any one of selected device keys. The key management device 40 then provides the bunch of the selected one or more device keys to the encryptor 22 of the recording device 20.

The encryptor 22 acquires each of the one or more device keys thus selected from the key management device 40, encrypts corresponding intermediate keys by using the acquired one or more device keys and stores the encrypted intermediate keys in the MKB. The outputter 23 then writes the MKB thus generated onto the recording medium 15. As a result, all the playback devices 30 each can decrypt an encrypted intermediate key contained in the MKB recorded on the recording medium 15 by using one of the device keys held secretly.

In the example of FIG. 8, the key management device 40 selects {Kd57, Kd58, Kd59, Kd60}. The encryptor 22 then encrypts corresponding intermediate keys {Kmp57, Kmp58, Kmp59, Kmp60} as follows by using the respective device keys to generate encrypted intermediate keys {E-Kmp57, E-Kmp58, E-Kmp59, E-Kmp60}. Note that Enc(x, y) represents a function of encrypting data y by using a key x.
E-Kmp57=Enc(Kd57, Kmp57)
E-Kmp58=Enc(Kd58, Kmp58)
E-Kmp59=Enc(Kd59, Kmp59)
E-Kmp60=Enc(Kd60, Kmp60)

As a result, all of the first to 32nd playback devices 30 each can obtain an intermediate key by decrypting the MKB by using one of the device keys that the playback device 30 holds.

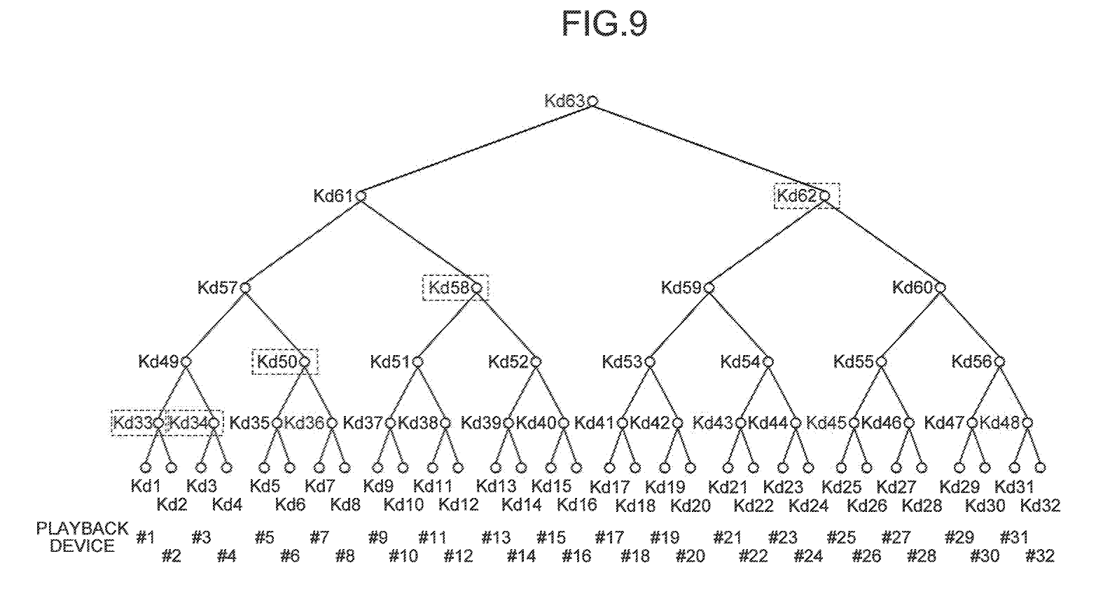

FIG. 9 illustrates another example of a bunch of one or more device keys used to encrypt an intermediate key when there is no device keys subjected to unauthorized use. The key management device 40 may select one or more device keys in another pattern.

For example, in the example of FIG. 9, the key management device 40 selects {Kd33, Kd34, Kd50, Kd58, Kd62}. The encryptor 22 then encrypts corresponding intermediate keys {Kmp33, Kmp34, Kmp50, Kmp58, Kmp62} as follows by using the respective device keys to generate encrypted intermediate keys {E-Kmp33, E-Kmp34, E-Kmp50, E-Kmp58, E-Kmp62}.
E-Kmp33=Enc(Kd33, Kmp33)
E-Kmp34=Enc(Kd34, Kmp34)
E-Kmp50=Enc(Kd50, Kmp50)
E-Kmp58=Enc(Kd58, Kmp58)
E-Kmp62=Enc(Kd62, Kmp62)

In this manner as well, all of the first to 32nd playback devices 30 each can obtain an intermediate key by decrypting the MKB by using one of the device keys that the playback device 30 holds.

The key management device 40 may select one or more device keys expect for device keys assigned to nodes from the root to a predetermined level in the key tree. In this case, each of the playback devices 30 need not hold the device keys assigned to the nodes from the root to the predetermined level. As a result, the number of devices to be held by each of the playback devices 30 can be reduced.

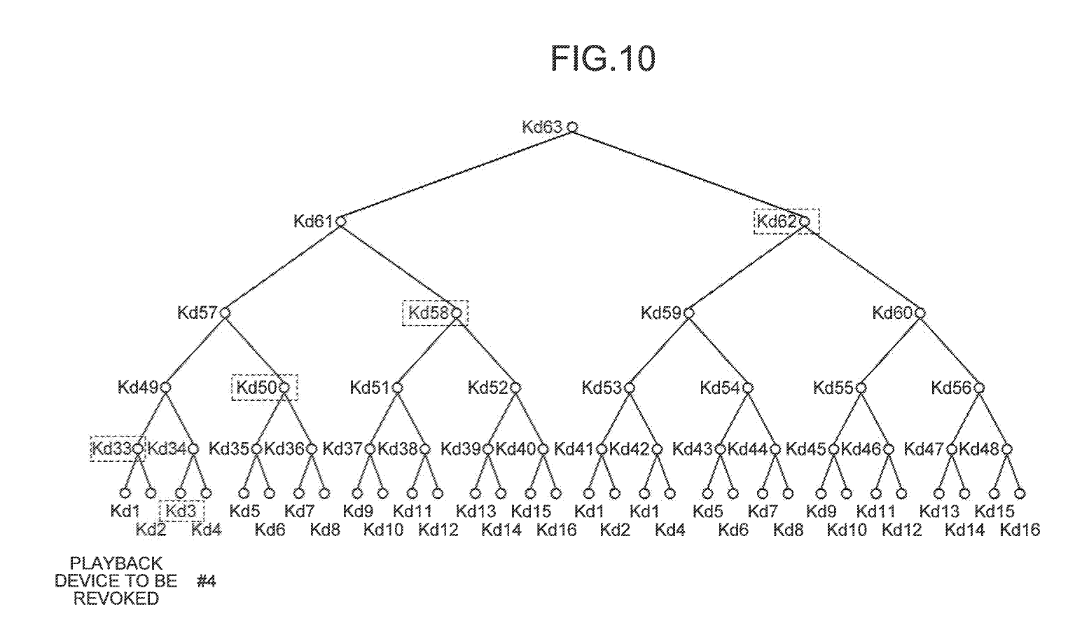

FIG. 10 indicates an example of a bunch of device keys used to encrypt intermediate keys when the playback device 30 associated with the fourth leaf from the left in the key tree is subjected to unauthorized use. When a device key of a certain playback device 30 is subjected to an unauthorized use, the key management device 40 revokes the playback device 30 so that the playback device 30 holding the device key subjected to an unauthorized key cannot obtain intermediate keys.

In this case, the key management device 40 selects one or more device keys (a bunch of device keys) so that all of the playback devices 30 except for the playback device 30 to be revoked each hold one device key. The key management device 40 then provides the bunch of the selected one or more device keys to the encryptor 22 of the recording device 20.

The encryptor 22 acquires each of the one or more device keys thus selected from the key management device 40, encrypts associated intermediate keys by using the acquired one or more device keys and stores the encrypted intermediate keys in the MKB. The outputter 23 then writes the MKB thus generated onto the recording medium 15.

As a result, the revoked playback device 30 cannot decrypt any of the encrypted intermediate keys contained in the MKB recorded on the recording medium 15. On the other hand, each of the playback devices 30 that are not revoked can decrypt one of the encrypted intermediate keys contained in the MKB recorded on the recording medium 15.

In the example of FIG. 10, the key management device 40 selects {Kd3, Kd33, Kd50, Kd58, Kd62}. The encryptor 22 then encrypts corresponding intermediate keys {Kmp3, Kmp33, Kmp50, Kmp58, Kmp62} as follows by using the respective device keys to generate encrypted intermediate keys {E-Kmp3, E-Kmp33, E-Kmp50, E-Kmp58, E-Kmp62}.
E-Kmp3=Enc(Kd3, Kmp3)
E-Kmp33=Enc(Kd33, Kmp33)
E-Kmp50=Enc(Kd50, Kmp50)
E-Kmp58=Enc(Kd58, Kmp58)
E-Kmp62=Enc(Kd62, Kmp62)

As a result, the fourth playback device 30 (#4) in the key tree cannot obtain any intermediate keys by using the device keys held therein. On the other hand, the playback devices 30 other than the fourth playback device 30 can obtain an intermediate key by using one of the device keys held therein.

The encryptor 22 generates such MKBs as described above as a first MKB and a second MKB. The first MKB and the second MKB are generated on the basis of key trees having the same branch pattern, and the leaves of the first MKB and the second MKB are respectively associated with the same playback devices 30. In the first MKB and the second MKB, the same device keys may be assigned to the respective nodes or different device keys may be assigned to the respective nodes.

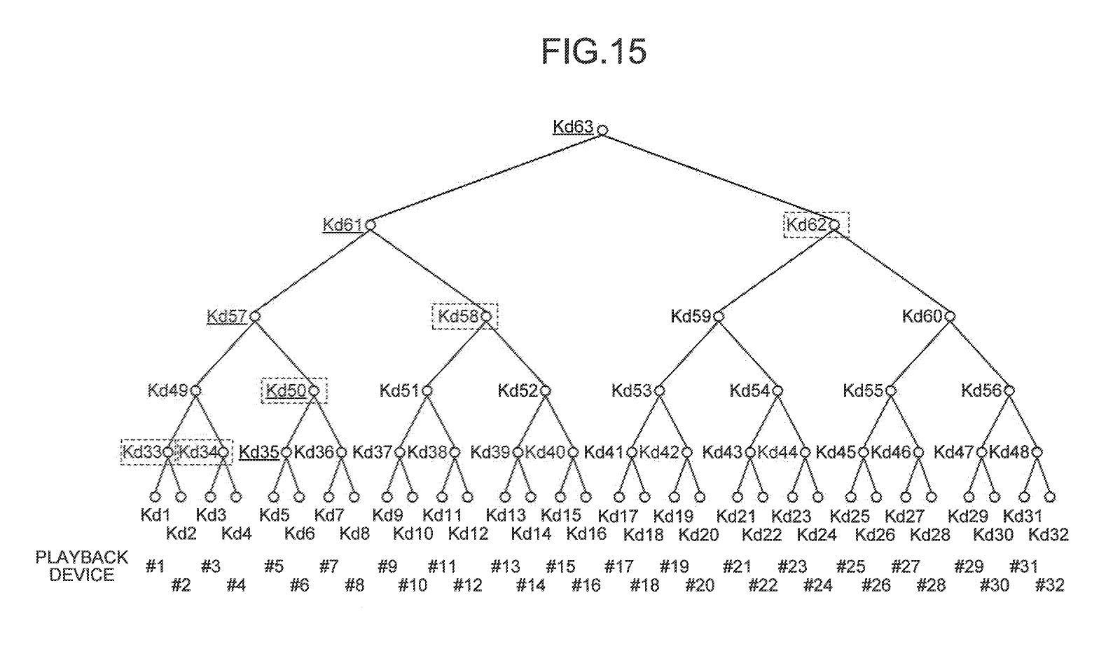

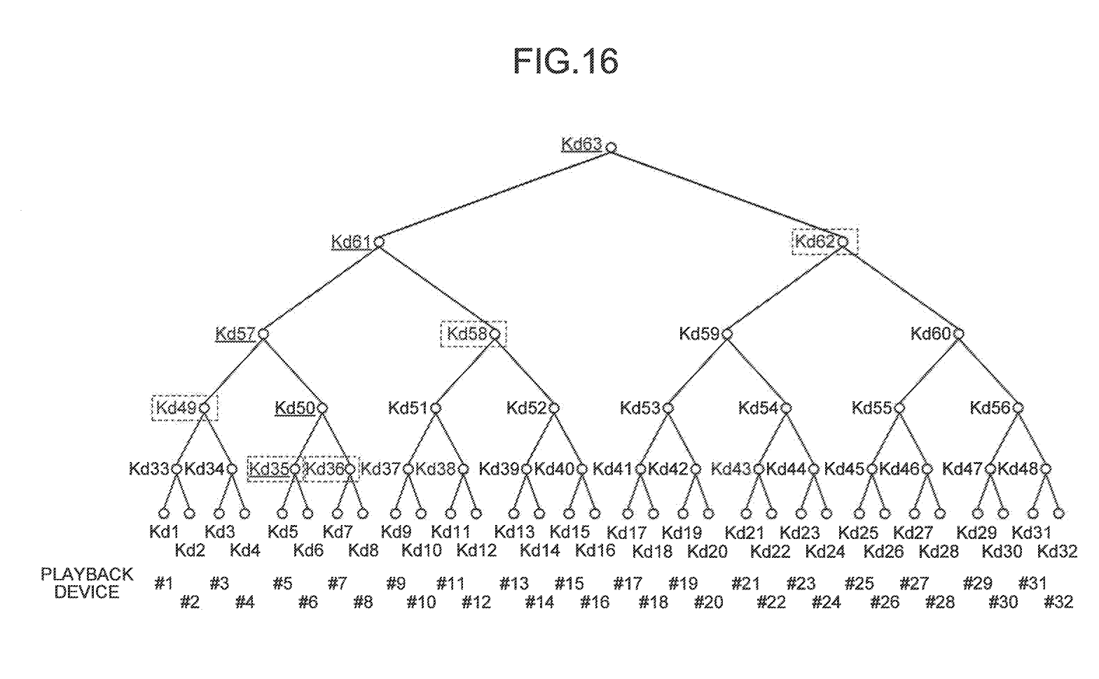

The key management device 40 selects a bunch of one or more device keys so that different combinations of nodes are assigned between the first MKB and the second MKB. As a result, for investigation of a playback device 30 suspected to be unauthorized, the key management device 40 can more accurately estimate the leaf to which the playback device 30 is associated in the key tree without reverse engineering of the playback devices 30. An example of the estimating method will be described further in detail with reference to FIGS. 15 and 16.

KCD Seed Block

Next, the first KCD seed block and the second KCD seed block will be described. In the present embodiment, the first KCD seed block and the second KCD seed block have the same role with respect to the first MKB and the second MKB, respectively, and will therefore be collectively described below.

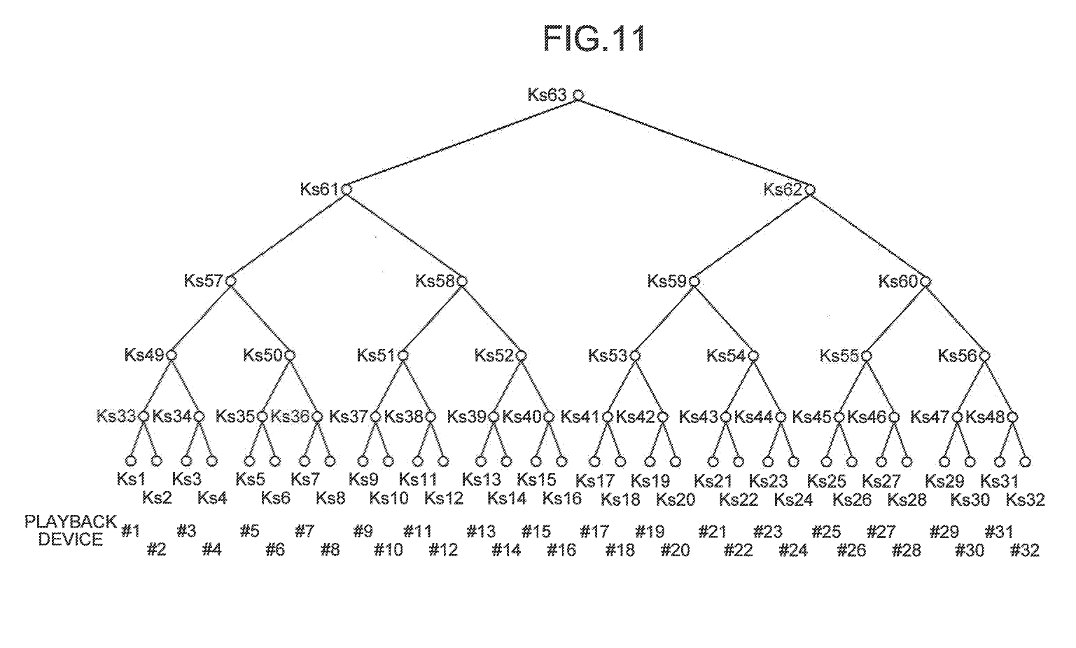

FIG. 11 illustrates a key tree in which KCD keys are assigned to respective nodes. The key management device 40 manages the key tree for generating the KCD seed block. The key tree is the same as that for generating a corresponding MKB.

Furthermore, multiple playback devices 30 are respectively associated with multiple leaves of the key tree. The positions of the leaves with which the playback devices 30 are associated are the same as those in the key tree for generating the corresponding MKB.

Furthermore, in the key tree, KCD keys that are different from one another are assigned to the respective nodes. In the example of FIG. 11, KCD keys Ks1 to Ks63 are respectively assigned to 63 nodes. The KCD keys assigned in the key tree may be the same or different between the first KCD seed block and the second KCD seed block.

Multiple KCD keys are distributed to each of the playback devices 30 from the key management device 40 during manufacture or the like. The positions of the nodes to which the distributed KCD keys are assigned are the same as those of the device keys distributed to the playback device 30. Each of the playback devices 30 then secretly holds the distributed KCD keys so that the KCD keys will not be exposed to access from outside.

The key management device 40 selects one or more KCD keys from the key tree and provides the selected KCD keys to the encryptor 22 of the recording device 20. The positions of the nodes to which the one or more KCD keys provided to the encryptor 22 are the same as those of the one or more device keys provided to the encryptor 22.

The encryptor 22 acquires each of the one or more KCD keys thus selected from the key management device 40, encrypts corresponding KCD values and position information by using the acquired one or more KCD keys to generate one or more KCD seeds. The encryptor 22 stores the one or more generated KCD seeds into the KCD seed block. The outputter 23 then writes the KCD seed block thus generated onto the recording medium 15.

As a result, the playback devices 30 each can decrypt a KCD seed contained in the KCD seed block recorded on the recording medium 15 by using one of the KCD keys held secretly. Furthermore, the playback devices 30 each can generate a KCD seed block in which one or more KCD seeds generated in one-to-one correspondence with the one or more encrypted intermediate keys E-Kmp stored in the associated MKB.

A KCD seed (KCD-seed), a KCD value (KCD), position information (Pos), a KCD key (Ks), and an intermediate key (Kmp) satisfy the following relation.

As expressed by the following expression, when a KCD seed (KCD-seed) and a KCD key (Ks) are input to a function f( ), a KCD value (KCD) and position information (Pos) are output. The position information Pos indicates the position of a node in the key tree to which the KCD key Ks is assigned.
(KCD, Pos)=f(Ks, KCD-seed)
   In addition, as expressed by the following expression, when a KCD value (KCD) and an intermediate key (Kmp) are input to a function g( ), a media key Km is output.
Km=g(Kmp, KCD)

Process Flow of Decryption Process

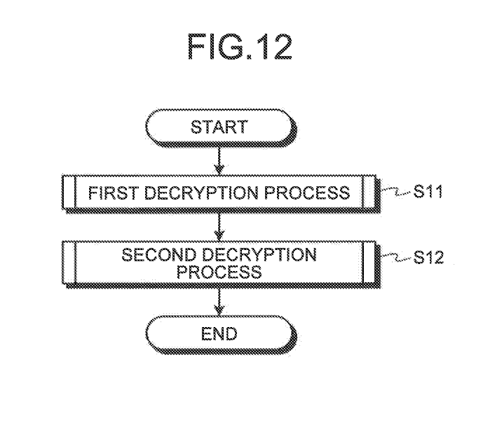

FIG. 12 illustrates a flow of a decryption process performed by the decryptor 32. As illustrated in FIG. 12, the decryptor 32 sequentially performs a first decryption process (S11) of decrypting encrypted content data to generate intermediate content data, and a second decryption process (S12) of converting the intermediate content data into plaintext content data. The decryptor 32 may perform part of the first decryption process and part of the second decryption process in parallel.

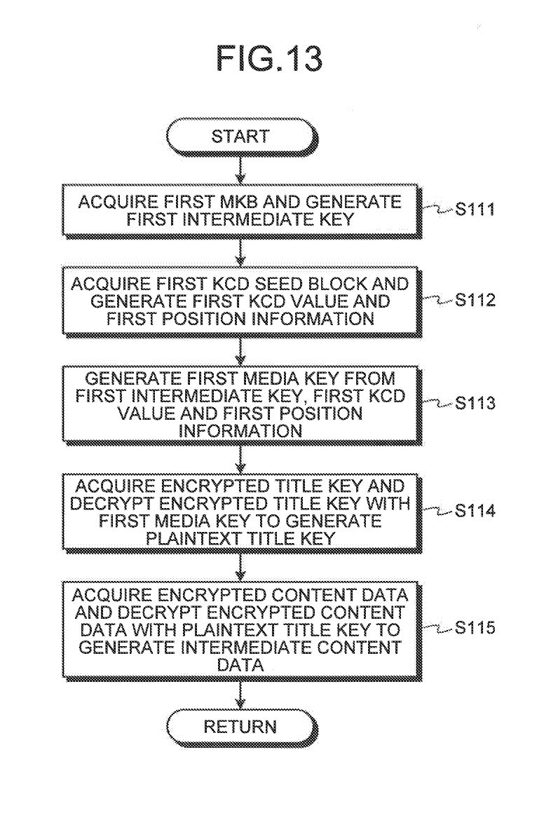

FIG. 13 illustrates a flow of the first decryption process. In the first decryption process, at Step Sill, the decryptor 32 first acquires the first MKB from the recording medium 15 and generates a first intermediate key.

Subsequently, at Step S112, the decryptor 32 acquires the first KCD seed block from the recording medium 15 and generates the first KCD value and the first position information. The order in which Step S111 and Step S112 are performed may be reversed or Step Sill and Step S112 may be performed at the same time. Subsequently, at Step S113, the decryptor 32 generates the first media key from the first intermediate key, the first KCD value, and the first position information.

Subsequently, at Step S114, the decryptor 32 acquires an encrypted title key from the recording medium 15. The decryptor 32 then decrypts the encrypted title key by using the first media key to generate a plaintext title key.

Subsequently, at Step S115, the decryptor 32 acquires encrypted content data from the recording medium 15. The decryptor 32 then decrypts the encrypted content data by using the plaintext title key to generate intermediate content data.

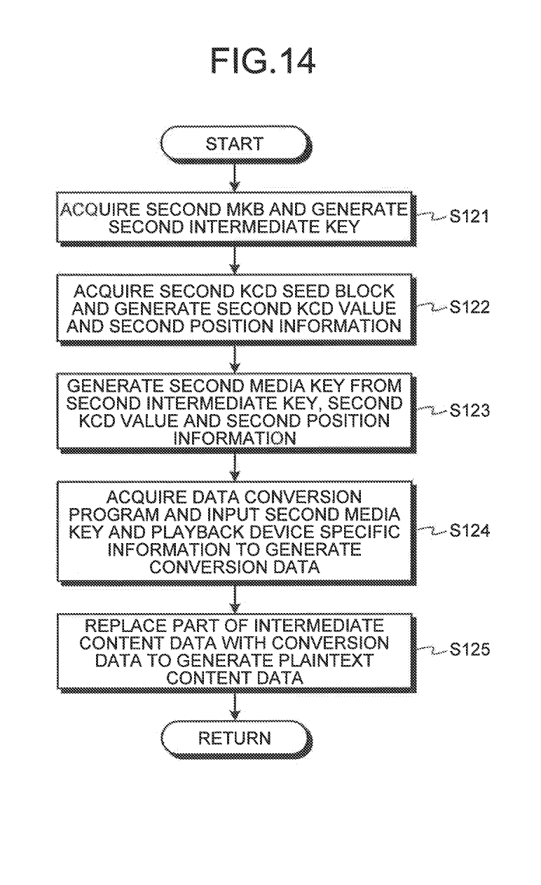

FIG. 14 illustrates a flow of the second decryption process. In the second decryption process, at Step S121, the decryptor 32 first acquires the second MKB from the recording medium 15 and generates a second intermediate key.

Subsequently, at Step S122, the decryptor 32 acquires the second KCD seed block from the recording medium 15 and generates the second KCD value and the second position information. Subsequently, at Step S123, the decryptor 32 generates the second media key from the second intermediate key, the second KCD value, and the second position information.

Subsequently, at Step S124, the decryptor 32 acquires the data conversion program from the recording medium 15. The decryptor 32 then causes a secure virtual machine to execute a program code contained in the data conversion program, and further inputs the second media key and the playback device specific information to the secure virtual machine to generate conversion data. Subsequently, at Step S125, the decryptor 32 replaces part of the intermediate content data with the conversion data to generate plaintext content data.

Estimation of Device Keys Held by Playback Device 30

FIG. 15 illustrates an example of one or more device keys used for encryption of encrypted intermediate keys to be stored in the first MKB. FIG. 16 illustrates an example of one or more device keys used for encryption of encrypted intermediate keys to be stored in the second MKB.

When a playback device 30 suspected to be unauthorized is found, the key management device 40 estimates the position of the leaf in the key tree associated with the suspected playback device 30 by using the first position information and the second position information acquired from the suspected playback device 30.

Furthermore, the key management device 40 selects one or more device keys so that different combinations of nodes are assigned between the first MKB and the second MKB. As a result, the key management device 40 can more accurately estimate the leaf in the key tree with which the playback device 30 is associated.

For example, as illustrated in FIG. 15, it is assumed here that the key management device 40 has selected five device keys {Kd33, Kd34, Kd50, Kd58, Kd62} for encryption of encrypted intermediate keys to be stored in the first MKB. For example, as illustrated in FIG. 16, it is also assumed here that the key management device 40 has selected five device keys {Kd35, Kd36, Kd49, Kd58, Kd62} for encryption of encrypted intermediate keys to be stored in the second MKB.

It is assumed here that the playback device 30 being investigated (the playback device 30 suspected to be in an unauthorized use) is associated with the sixth leaf from the left. Note that the key management device 40 does not recognize which leaf the playback device 30 being investigated is associated with.

In this case, the playback device 30 being investigated decrypts the first MKB by using the device key Kd50. The playback device 30 being investigated thus outputs the first position information indicating the position of the node Kd50. The key management device 40 acquires the first position information of the playback device 30 being investigated and compares the first position information with the key tree that the key management device 40 manages. As a result, the key management device 40 can estimate that the playback device 30 being investigated is associated with one of the fifth to eighth leaves from the left.

The playback device 30 being investigated also decrypts the second MKB by using the device key Kd35. The playback device 30 being investigated thus outputs the second position information indicating the position of the node Kd35. The key management device 40 acquires the second position information of the playback device 30 being investigated and compares the second position information with the key tree that the key management device 40 manages. As a result, the key management device 40 can estimate that the playback device 30 being investigated is associated with one of the fifth to sixth leaves from the left.

In this manner, when the playback device 30 being investigated is associated with the sixth leaf from the left, the key management device 40 can more accurately estimate the position of the leaf with which the playback device 30 being investigated is associated by referring to the second position information rather than the first position information.

For another example, it is assumed that the playback device 30 being investigated is associated with the second leaf from the left. In this case, the playback device 30 being investigated decrypts the first MKB by using the device key Kd33. The playback device 30 being investigated thus outputs the first position information indicating the position of the node Kd33. As a result of obtaining the first position information in this manner, the key management device 40 can estimate that the playback device 30 being investigated is associated with one of the first to second leaves from the left.

The playback device 30 being investigated also decrypts the second MKB by using the device key Kd49. The playback device 30 being investigated thus outputs the second position information indicating the position of the node Kd49. As a result of obtaining the second position information in this manner, the key management device 40 can estimate that the playback device 30 being investigated is associated with one of the first to fourth leaves from the left.

In this manner, when the playback device 30 being investigated is associated with the second leaf from the left, the key management device 40 can more accurately estimate the position of the leaf with which the playback device 30 being investigated is associated by referring to the first position information rather than the second position information.

As described above, the encryption system 10 according to the present embodiment uses multiple MKBs (the first MKB and the second MKB, for example) recorded in an inseparable manner on one recording medium 15, and selects one or more device keys so that different combinations of nodes are assigned between the MKBs. As a result, according to the encryption system 10, content protection can be enhanced as compared to the conventional method of estimating the position of a leaf associated with a playback device 30 being investigated by combining multiple recording media 15 each having one MKB recorded thereon. Furthermore, according to the encryption system 10, the leaf in the key tree with which a playback device 30 being investigated is associated can be more accurately estimated.

In particular, when an unauthorized playback device holds device keys acquired in an unauthorized manner from two or more playback devices and switches between the device keys depending on the recording media for reproduction, the accuracy of estimating the leaf position cannot be improved if only one MKB is recorded on one recording medium even if the pieces of position information of multiple leaves obtained by processing the MKBs recorded on the respective recording media by the playback device are combined. In contrast, with the encryption system 10 according to the present embodiment, the accuracy of estimating the leaf position can be improved by combining the pieces of position information of multiple leaves obtained by processing multiple MKBs recorded on at least one recording medium 15 by the playback device 30.

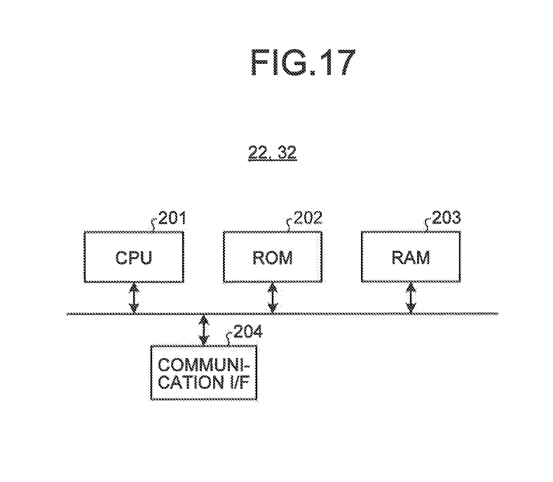

FIG. 17 is a diagram illustrating an example of a hardware configuration of the encryptor 22 and the decryptor 32. Each of encryptor 22 and the decryptor 32 includes a controller such as a central processing unit (CPU) 201, storage devices such as a read only memory (ROM) 202 and a random access memory (RAM) 203, a communication interface (I/F) 204 for connecting to a network and establishing communications, and a bus for connecting these components.

Programs to be executed by the encryptor 22 and the decryptor 32 according to the embodiment are embedded on the ROM 202 or the like in advance and provided therefrom. The programs may alternatively be recorded on a computer readable recording medium such as a compact disk read only memory (CD-ROM), a flexible disk (FD), a compact disk recordable (CD-R), and a digital versatile disk (DVD) in a form of a file that can be installed or executed, and provided as a computer program product.

Alternatively, the programs may be stored on a computer system connected to a network such as the Internet, and provided by being downloaded via the network. Still alternatively, the programs may be provided or distributed through a network such as the Internet.

The programs to be executed by the decryptor 32 according to the embodiment can cause a computer to function as the respective components (the first data decryptor 51, the second data decryptor 52, the first key generator 53, and the second key generator 54) of the decryptor 32 described above. Note that part or the whole of the first data decryptor 51, the second data decryptor 52, the first key generator 53, and the second key generator 54 may be implemented by hardware.

The programs to be executed by the encryptor 22 according to the present embodiment can cause a computer to function as the respective components (the first data encryptor 81, the second data encryptor 82, the first key encryptor 83, and the second key encryptor 84) of the encryptor 22 described above. Note that part or the whole of the first data encryptor 81, the second data encryptor 82, the first key encryptor 83, and the second key encryptor 84 may be implemented by hardware.

In the computer, the CPU 201 can read out programs from a computer-readable storage medium onto a main storage unit and execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A decrypting device comprising:
multiple data decryptors configured to decrypt encrypted data through processes different from one another; and
multiple key generators provided respectively corresponding to the data decryptors, and configured to generate key information to be used in corresponding decryption processes, wherein
a key tree includes multiple nodes in a tree structure,
lowermost nodes among the nodes are leaves,
the leaves are respectively associated with playback devices,
device keys different from one another are respectively assigned to the nodes, and
each of the key generators includes:
a device key holder configured to hold the device keys assigned to the nodes in the key tree; and
a key decryptor configured to:
acquire key management information containing one or more pieces of encrypted key information each obtained by encrypting the key information by using each of one or more device keys selected from the key tree,
select one device key that can be used for decryption of the key management information from the device keys held by the key device holder, and
generate the key information by decrypting the key management information by using the selected device key.

2. The device according to claim 1, wherein the device key holder at least holds multiple device keys assigned to nodes on a path from a root or a node at an intermediate level to a leaf associated with a corresponding playback device in the key tree.

3. The device according to claim 1, wherein each of the key generators further includes a position detector configured to detect position information indicating a position of a node in the key tree to which a device key used to decrypt the encrypted key information contained in the key management information is assigned.

4. The device according to claim 3, wherein the position detector outputs position information indicating the position to a data area that can be referred to from outside.

5. The device according to claim 1, wherein
the one or more pieces of encrypted key information contained in the key management information are information generated by encrypting the key information by using the one or more device keys selected so that each of all the playback devices except for a playback device to be revoked has one device key, and
when one or more pieces of the key management information indicate revocation as a result of decrypting the one or more pieces of key management information, a result different from that when no revocation is indicated is output.

6. The device according to claim 5, wherein the one or more pieces of encrypted key information contained in the key management information are information generated by encrypting the key information by using the one or more device keys selected so that node combination patterns are different from one another.

7. The device according to claim 1, wherein each of the data decryptors decrypts data read from a recording medium.

8. The device according to claim 7, wherein the key management information is information on a media key block (MKB) defined in an advanced access content system (AACS).

9. A computer program product comprising a computer-readable medium containing a computer program, the program causing a computer to operate the decrypting device according to claim 1.

10. An encrypting device comprising:
multiple data encryptors configured to encrypt data through processes different from one another; and
multiple key encryptors provided respectively corresponding to the data encryptors, and configured to encrypt key information to be used in corresponding decryption processes, wherein
a key tree includes multiple nodes in a tree structure,
lowermost nodes among the nodes are leaves,
the leaves are respectively associated with playback devices,
device keys different from one another are respectively assigned to the nodes, and
each of the key encryptors includes:
a device key acquirer configured to acquire one or more device keys selected from the key tree; and
a key information generator configured to generate key management information containing one or more pieces of encrypted key information each obtained by encrypting the key information by using each of the one or more acquired device keys.

11. The device according to claim 10, wherein
each of the playback devices holds multiple device keys assigned to the nodes in the key tree, and
the device key acquirer acquires the one or more device keys selected so that each of all the playback devices except for a playback device to be revoked has one device key.

12. The device according to claim 11, wherein the device key acquirer acquires the one or more device keys selected so that node combination patterns are different between decryption processes.

13. The device according to claim 12, wherein each of the key encryptors further includes a position information generator configured to add, to the key management information, position information indicating a position of a node in the key tree to which a device key used to decrypt the encrypted key information contained in the key management information is assigned.

14. The device according to claim 11, wherein each of the data encryptors is configured to generate data to be written onto a recording medium.

15. The device according to claim 14, wherein the key management information is information on a media key block (MKB) defined in an advanced access content system (AACS).

16. A computer program product comprising a computer-readable medium containing a computer program, the program causing a computer to operate the encrypting device according to claim 1.

17. A recording medium comprising:
a first area in which data encrypted through processes different from one another are stored; and
a second area in which multiple pieces of key management information containing key information to be used in decryption processes are stored respectively corresponding to the processes, wherein
a key tree includes multiple nodes in a tree structure,
lowermost nodes among the nodes are leaves,
the leaves are respectively associated with playback devices,
device keys different from one another are respectively assigned to the nodes, and
each of the multiple pieces of key management information contains one or more pieces of encrypted key information obtained by selecting one or more device keys from the key tree, and encrypting the key information by using the one or more selected device keys.

18. A method for manufacturing a recording medium, comprising:
multiple data encrypting steps of encrypting data through processes different from one another;
multiple key encrypting steps, being respectively corresponding to the data encrypting steps, of encrypting key information to be used in corresponding decryption processes; and
a recording step of recording the data encrypted in the data encrypting steps and the key information encrypted in the key encrypting steps onto a recording medium, wherein
a key tree includes multiple nodes in a tree structure,
lowermost nodes among the nodes are leaves,
the leaves are respectively associated with playback devices,
device keys different from one another are respectively assigned to the nodes, and
each of the key encrypting steps includes:
acquiring one or more device keys selected from the key tree; and
generating key management information containing one or more pieces of encrypted key information each obtained by encrypting the key information by using each of the one or more acquired device keys.

19. The method for manufacturing a recording medium according to claim 18, wherein
each of the playback devices holds multiple device keys assigned to the nodes in the key tree, and
each of the key encrypting steps includes acquiring the one or more device keys selected from the key tree so that each of all the playback devices except for a playback device to be revoked has one device key.
